(19) United States
(12) Patent Application Publication
(10) Pub. No.: US 2016/0111209 A1
(43) Pub. Date: Apr. 21, 2016

(54) PLANAR CORE WITH HIGH MAGNETIC VOLUME UTILIZATION

(71) Applicant: Fred O. Barthold, Leucadia, CA (US)

(72) Inventor: Fred O. Barthold, Leucadia, CA (US)

(21) Appl. No.: 14/977,568

(22) Filed: Dec. 21, 2015

Related U.S. Application Data
(63) Continuation of application No. 14/247,000, filed on Apr. 7, 2014, now Pat. No. 9,251,945.

(51) Int. Cl. H01F 41/02

(52) U.S. Cl. CPC H01F 41/02

(57) ABSTRACT

A disclosed method comprises: specifying a WₐA_{c} product of a first transformer having a three-legged core; determining a window area Wₐ of the first transformer; determining parameters of the first transformer, including a core area A_{c}, a height of c, and a width of b; specifying, based at least in part on the parameters of the first transformer, a second transformer having the WₐA_{c} product, the window area Wₐ, and the core area A_{c} and comprising: a first magnetic portion comprising: a first plurality of leg posts that is to be surrounded by a first set of windings; and a first plurality of center portions that is not to be surrounded by windings; and a second magnetic core portion comprising: a second plurality of leg posts that is to be surrounded by a second set of windings; and a second plurality of center portions that do not receive windings.

### CROSS REFERENCE TO OTHER APPLICATIONS

This application is a continuation of co-pending U.S. patent application Ser. No. 14/247,000, entitled PLANAR CORE WITH HIGH MAGNETIC VOLUME UTILIZATION filed Apr. 7, 2014 which is incorporated herein by reference for all purposes, which claims priority to U.S. Provisional Patent Application No. 61/810,091 entitled PLANAR CORE-TYPE UNIFORM EXTERNAL FIELD EQUALIZER AND A PLANAR CORE FOR MAXIMUM MAGNETIC VOLUME UTILIZATION filed Apr. 9, 2013 which is incorporated herein by reference for all purposes.

### BACKGROUND OF THE INVENTION

The design and optimization efforts of electrical/electronic magnetic structures such as transformers often involve adjusting the dimensions of the magnetic core. Depending on the application, the requirements for dimensions and volume of the structure can differ. For example, a device that needs to handle 1 kW of power will be significantly greater in size than a device made of the same material but only needs to handle 1 W of power.

A commonly used design parameter is the WₐA_{c} product, which determines the device's power-handling capability. Wₐ is referred to as the window area, and A_{c} is referred to as the core area. When designing a magnetic core, the designer typically starts with a specification of the WₐA_{c} product and chooses a core structure that meets the specification. Many conventional core structures, however, are sub-optimal in terms of their magnetic volume utilization and can lead to excess core loss.

### BRIEF DESCRIPTION OF THE DRAWINGS

Various embodiments of the invention are disclosed in the following detailed description and the accompanying drawings.

FIG. 1 is a three-dimensional diagram illustrating an example of a transformer with a three-legged magnetic core structure.

FIGS. 2A-2C are projection views of an example transformer with a three-legged magnetic core structure, such as transformer 100 of FIG. 1.

FIG. 3 is an exploded view of an embodiment of a planar core-type transformer.

FIG. 4A is a top view of PWB structure 302 as shown in FIG. 3.

FIG. 4B is a cross sectional view of an example of an embodiment of a planar transformer comprising a uniform field equalizer.

FIG. 5A is a top view of an embodiment of a core half structure such as 304a or 304b.

FIG. 5B is a three dimensional view of an embodiment of a core half structure such as 304a or 304b.

FIG. 5C is a side view of an embodiment of a core half structure such as 304a or 304b.

FIGS. 6A-6C are projection views of an embodiment of a planar-core type transformer such as 300 of FIG. 3.

FIG. 7 is a flowchart illustrating an embodiment of a process (700) for constructing a device with a modified magnetic core.

FIG. 8 is a diagram illustrating an enlarged cross sectional view that corresponds to region 330 shown in FIG. 4B.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A planar-core type transformer with alternative core geometry is disclosed. In some embodiments, the transformer has a magnetic core structure comprising a first portion and a second portion. Each portion includes leg posts that are to be surrounded by a corresponding set of windings, and center portions that are not to be surrounded by windings. In some embodiments, parameters of the core portions are derived based on parameters of a transformer with a conventional three-legged core.

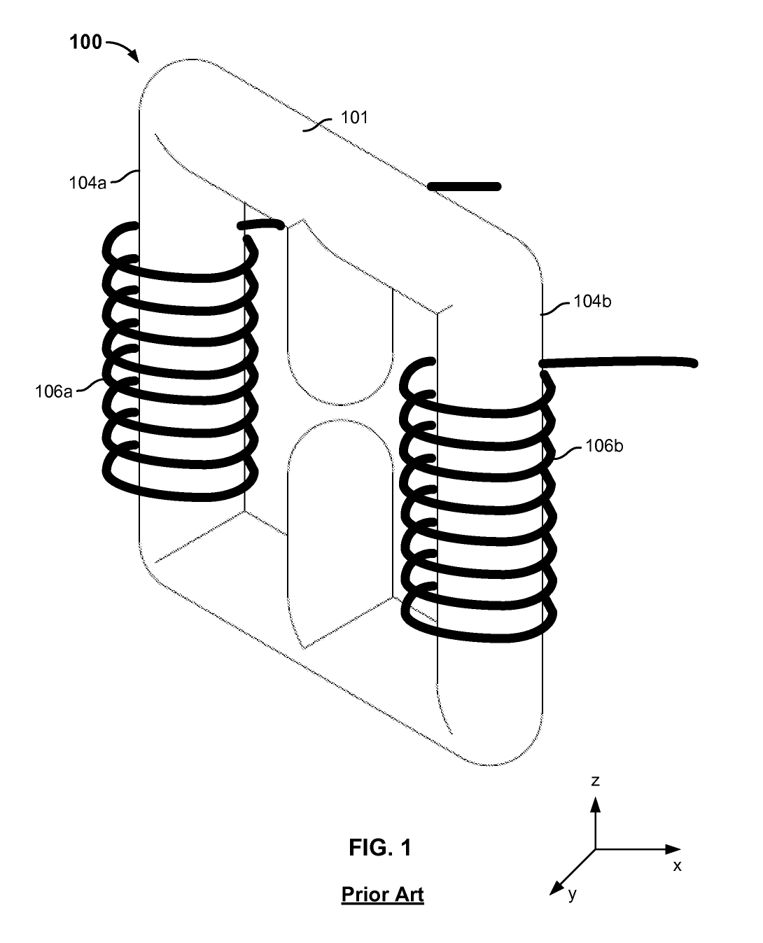

FIG. 1 is a three-dimensional diagram illustrating an example of a transformer with a three-legged magnetic core structure. Transformer 100 includes two sets of windings 106a and 106b and a three-legged magnetic core 101. The windings are formed using conductive coils or wires, and surround two outer leg posts 104a and 104b.

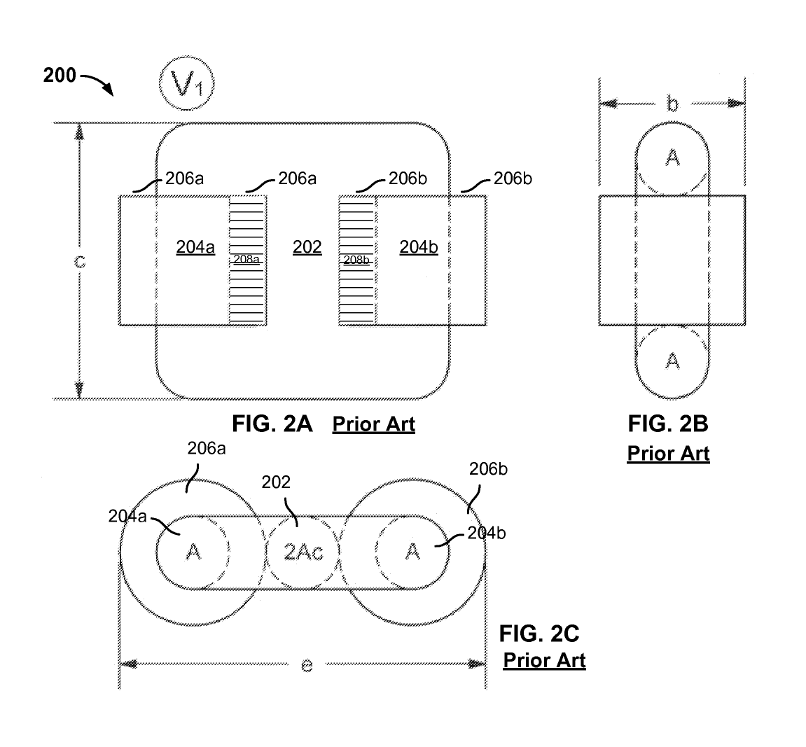

FIGS. 2A-2C are projection views of an example transformer with a three-legged magnetic core structure, such as transformer 100 of FIG. 1.

FIG. 2A illustrates the front view of the example transformer along the y-axis. Magnetic core structure 200 includes a center leg post 202 and two outer leg posts 204a and 204b. The windings surrounding the outer leg posts are illustrated as 206a and 206b. Shaded areas 208a or 208b (areas between the center leg post and one of the outer leg posts) are each referred to as the window area, denoted as Wₐ. The number of turns in each set of windings and the cross sectional area of the wire used to construct the windings are constrained by the value of Wₐ since the total cross sectional area of the windings cannot exceed this value. The height of the core structure is denoted as c.

FIG. 2B illustrates the side view of the example transformer along the x-axis. The top and bottom portions of the core have the same diameter as the outer leg posts to avoid loss due to flux density changes. The core has a cross sectional area of A. The width of the structure including the windings surrounding the core is denoted as b.

FIG. 2C illustrates the top view of the example transformer along the z-axis. Windings 206a surrounding outer leg post 204a and windings 206b surrounding outer leg post 204b are separated by center leg post 202. The center leg post's cross sectional area is denoted as 2A_{c}. In this example, the center leg post has the same cross sectional area as each outer leg post. The length of the structure including the windings surrounding the core is denoted as e.

The volume of the device shown in FIGS. 2A-2C is the product of b, c, and e (bce).

In some planar applications where the windings of a transformer are embedded in a printed wiring board (PWB) (also referred to as a printed circuit board (PCB)), a conventional three-legged magnetic core geometry occupies a greater volume than necessary and can be unsuitable for certain designs with space constraints. The extra magnetic path length also leads to additional core loss. To reduce the volume of the transformer, a planar core-type transformer with a different core geometry is constructed while the area of the gapped magnetic path (A_{c}) and the window area parameter (Wₐ) are maintained. Specifically, a transformer with less volume is implemented using a core structure that redistributes the center area (2A_{c}) of the conventional three-legged core structure. Details of the structure and parameters of the transformer and its magnetic core are described below.

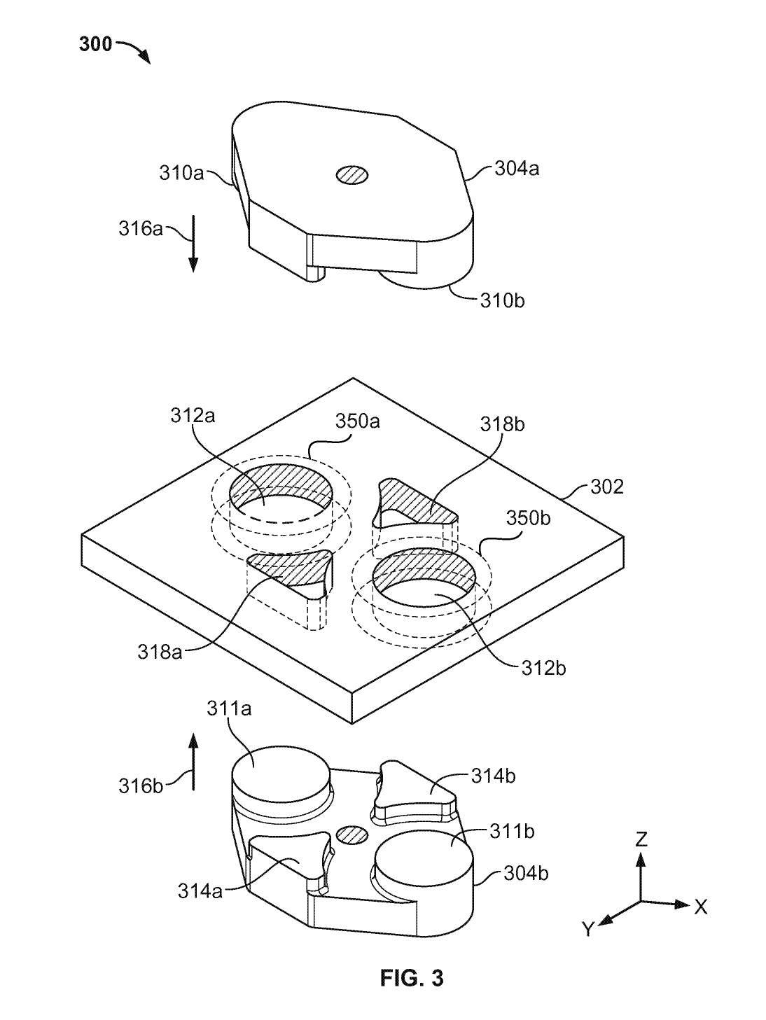

FIG. 3 is an exploded view of an embodiment of a planar core-type transformer. In this example, transformer 300 includes a planar structure 302 that is formed in a printed wiring board (PWB), and a set of magnetic core halves 304a and 304b constructed using ferrite, silicon steel, or other appropriate magnetic material.

As shown, the magnetic core halves are identical structures. In a transformer assembly, the magnetic core halves are positioned to face each other. One side of the structure, 304a, is substantially flat. The other side of the structure, 304b, has circular protrusions 311a and 311b, and non-circular protrusions 314a and 314b.

Planar structure 302 includes a number of openings configured to receive two magnetic core halves 304a and 304b. Built into the PWB are a number of conductive layers (e.g., copper, alloy, etc.) separated by layers of insulating material (e.g., plastic, polymer, etc.). In this example, at least a portion of the conductive layers of the PWB forms the two sets of windings of the transformer in regions surrounding circular openings 312a and 312b. The windings (not shown) are embedded in the PWB using known techniques such as laminating or electroplating coils on individual layers and connecting the layers using vias. In some embodiments, the planar structure includes additional features such as equalizers formed using conductive plates and traces.

The transformer is assembled by placing the protrusions of magnetic core halves within the corresponding openings on the planar structure 302 and bringing the magnetic core halves together in the directions shown by arrows 316a and 316b, such that the surfaces of circular protrusions 310a and 311a are in contact, and the surfaces of circular protrusions 310b and 311b are in contact. Together, protrusions 310a and 311a join together to form one leg post of the core structure, and protrusions 310b and 311b join together to form another leg post. Since openings 312a and 312b are surrounded by the inductive windings formed in planar structure 302, when the core halves are brought together to form leg posts extending through the openings, the leg posts are also surrounded by the inductive windings.

Non-circular protrusions such as 314a and 314b (also referred to as the center portions) and their counterparts on core half 304 are placed through openings 318a and 318b, respectively. Since the non-circular protrusions are shorter than the circular protrusions, in the transformer assembly, the surfaces of the non-circular protrusions are not in contact and there is a gap between the non-circular protrusions. Further, the non-circular protrusions do not receive any inductive windings. In other words, since there are no windings surrounding openings 318a and 318b, there are no windings surrounding the non-circular protrusions. When a voltage is applied to the primary winding, magnetic flux is generated. Since the flux must form a complete loop, at least some of the magnetic flux generated by the inductive windings is redirected to return via the non-circular protrusions to complete a loop. In other words, the center portions provide physically separate paths for the magnetic flux. For example, assume that 8 units of magnetic flux is generated by a primary winding and crosses leg post 311a, half of which (4 units) is directed to leg post 311b. Accordingly, the remaining 4 units of magnetic flux is directed to center portions 314a and 314b. Because the center portions are constructed to be symmetrical, the flux is evenly divided, such that 2 units of the magnetic flux crosses each of the center portions.

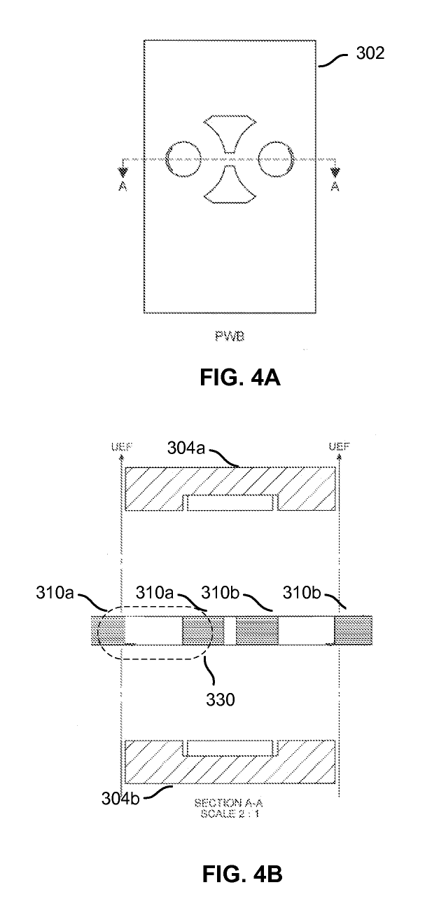

FIG. 4A is a top view of PWB structure 302 as shown in FIG. 3. The circular and non-circular openings are shown.

FIG. 4B is a cross sectional view of an example of an embodiment of a planar transformer comprising a uniform field equalizer. In this example, a cross section along the line AA illustrated in FIG. 4A and perpendicular to the top and bottom surfaces of the PWB is shown. As shown, the PWB used to construct the transformer has a number of conductive layers comprising conductive material such as copper or alloy. The conductive layers are separated by insulating layers comprising non-conductive material such as plastic or polymer. The inductive coils can be formed using known techniques such as etching or electroplating a turn of the winding on each layer, and connecting the winding turns in different layers using vias to form the windings. The number of layers and PWB thickness depend on the requirements of the application and may vary in different embodiments. Cross sections of conductive layers 310a-310b are shown. Magnetic core halves 304a and 304b are also illustrated.

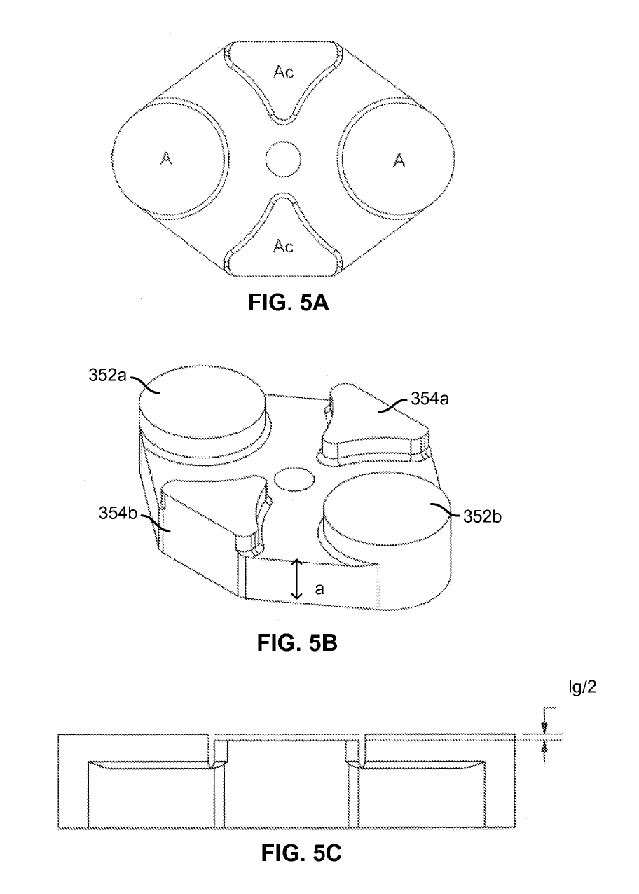

FIG. 5A is a top view of an embodiment of a core half structure such as 304a or 304b. FIG. 5B is a three dimensional view of an embodiment of a core half structure such as 304a or 304b. In some embodiments, the core half structure is constructed using ferrite material. Outer leg protrusions 352a and 352b are taller than center protrusions 354a and 354b so that when two magnetic core halves are brought together in the transformer assembly, a gap is formed between the center protrusions. The structure may be formed by machining, casting, molding (including injection molding), or any other appropriate techniques. FIG. 5C is a side view of an embodiment of a core half structure such as 304a or 304b. The height difference of protrusions 354a (or 354b) and protrusions 352a (or 352b) is one half of the total gap distance of the transformer (represented as lg/2).

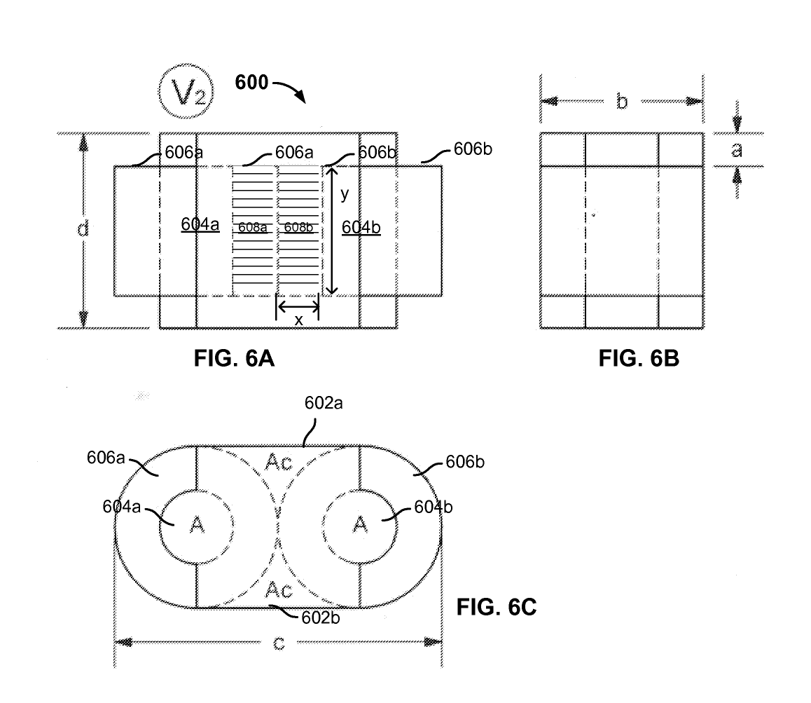

FIGS. 6A-6C are projection views of an embodiment of a planar-core type transformer such as 300 of FIG. 3.

FIG. 6A illustrates the front view of the transformer embodiment along the y-axis. Magnetic core structure 600 includes two leg posts 604a and 604b. The windings surrounding the leg posts are illustrated as 606a and 606b. Shaded areas 608a and 608b (the areas between a leg post and the center of the core structure) are each referred to as the window area. This window area is maintained to be Wₐ, which is the same as the window area of structure 200 of FIG. 2A. The height of the core structure is denoted as d. In this case, the height of core 600 is represented as d.

FIG. 6B illustrates the side view of the transformer embodiment along the x-axis. The width of the structure is denoted as b, the thickness of the core plate is represented as a. The cross sectional area of the core plate (ab) is maintained to be the same as the cross sectional area A of FIG. 2B.

FIG. 6C illustrates the top view of the transformer embodiment along the z-axis. Windings 606a surrounding leg post 604a is adjacent to windings 606b surrounding leg post 604b without being separated by a center leg as the structure shown in FIG. 2C. The cross sectional area of each leg post is denoted as A. Compared with FIG. 2C, the cross sectional area of center leg post 202 is distributed to two center portions 602a and 602b, each having a cross sectional area of A_{c}.

The volume of the transformer embodiment shown in FIGS. 6A-6C is computed as bcd.

The relationships of the parameters (dimensions, volumes, and areas) of the structure shown in FIGS. 2A-2C and the structure shown in FIGS. 6A-6C are as follows:

$${W}_{a} = \frac{8 A}{π} \qquad ( 1 )$$

where Wₐ is the window area, A corresponds to the cross sectional area of a leg post.

A=2A_{c}=ab (2)

where A_{c} corresponds to the core area in both figures, a corresponds to the thickness of the core base (as shown in FIG. 5B), and b corresponds to the core width of both FIG. 2B and FIG. 6B.

$$\begin{matrix}b = 4 \sqrt{A / π} = 4 \sqrt{2 {A}_{c} / π} & ( 3 ) \\ a = \frac{A}{b} = \frac{2 {A}_{c}}{b} & ( 4 ) \\ c = 8 \sqrt{\frac{A}{π}} = 8 \sqrt{\frac{2 {A}_{c}}{π}} & ( 5 )\end{matrix}$$

where c corresponds to the core length of FIG. 6C and the core height of FIG. 2A.

$$e = 10 \sqrt{\frac{A}{π}} \qquad ( 6 )$$

where e corresponds to the core length of FIG. 2C.

$$d = 5.6 \sqrt{\frac{A}{π}} = 5.6 \sqrt{\frac{2 {A}_{c}}{π}} \qquad ( 7 )$$

where d corresponds to the core height of FIG. 6A.

$${V}_{1} = bce = 320 \frac{A}{π} \sqrt{\frac{A}{π}} \qquad ( 8 )$$

where V₁ corresponds to the volume of the core structure of FIGS. 2A-2C.

$${V}_{2} = bcd = 179.2 \frac{A}{π} \sqrt{\frac{A}{π}} \qquad ( 9 )$$

where V2 corresponds to the volume of the core structure of FIGS. 6A-6C.

$$\frac{{V}_{2}}{{V}_{1}} = 0.56 \qquad ( 10 )$$

As can be seen, the transformer design of FIG. 3 maintains the same window area (Wₐ) and the core cross section (A_{c}) as FIG. 2A while reducing the volume substantially. In addition, the total length of the magnetic path is reduced, leading to enhancements in open circuit inductance (OCL) and effective permeability (μₑ).

To design a magnetic core structure used in a planar-core type transformer such as 300, a WₐA_{c} product is specified based on requirements of the application, using known techniques. For example, in some embodiments, the product is specified according to:

$${W}_{a} {A}_{c} = \frac{{P}_{o} {D}_{cma}}{{K}_{t} {B}_{max} f} \qquad ( 11 )$$

where Pₒ corresponds to power out, D_{cma} corresponds to current density, Bₘₐₓ corresponds to flux density, Kₜ is a constant based on the type of topology, and f corresponds to the frequency.

The window area (Wₐ) is then determined. In some embodiments, the determination is based at least in part on the thickness and the width of the windings and the number of turns in a winding. Referring to FIG. 6A for an example, the width of the winding coils corresponds to x; the thickness of each layer in the PWB multiplied by the number of turns in the winding corresponds to y. Accordingly,

Wₐ=x*y (12)

The value of core area A_{c} is then determined based on WₐA_{c} and Wₐ, and dimensions a, b, c, and d are determined according to equations (3)-(7) to specify a structure similar to what is shown in FIG. 3 and FIGS. 6A-6C.

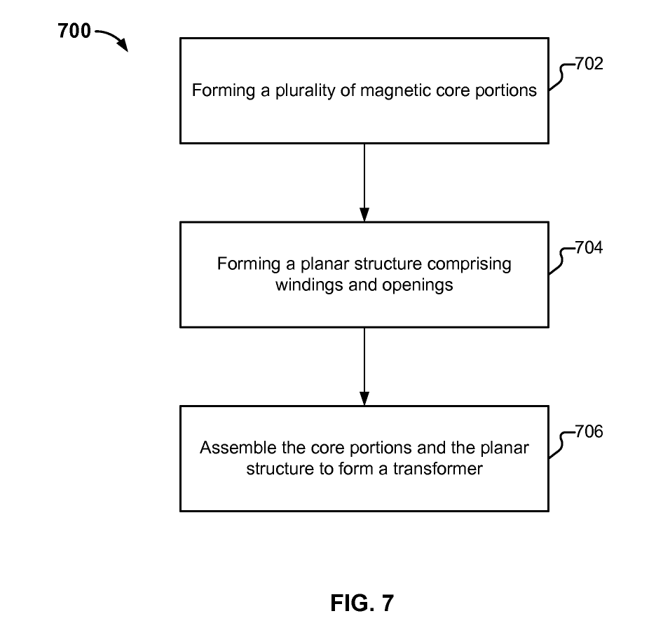

FIG. 7 is a flowchart illustrating an embodiment of a process for constructing a device with a modified magnetic core.

Process 700 starts at 702, where a plurality of magnetic core portions (e.g., two core halves), each having leg posts to be surrounded by sets of windings and center posts that are not to be surrounded by the windings, are formed. In various embodiments, the magnetic core portions are formed using techniques such as machining, casting, molding (including injection molding), or any other appropriate techniques.

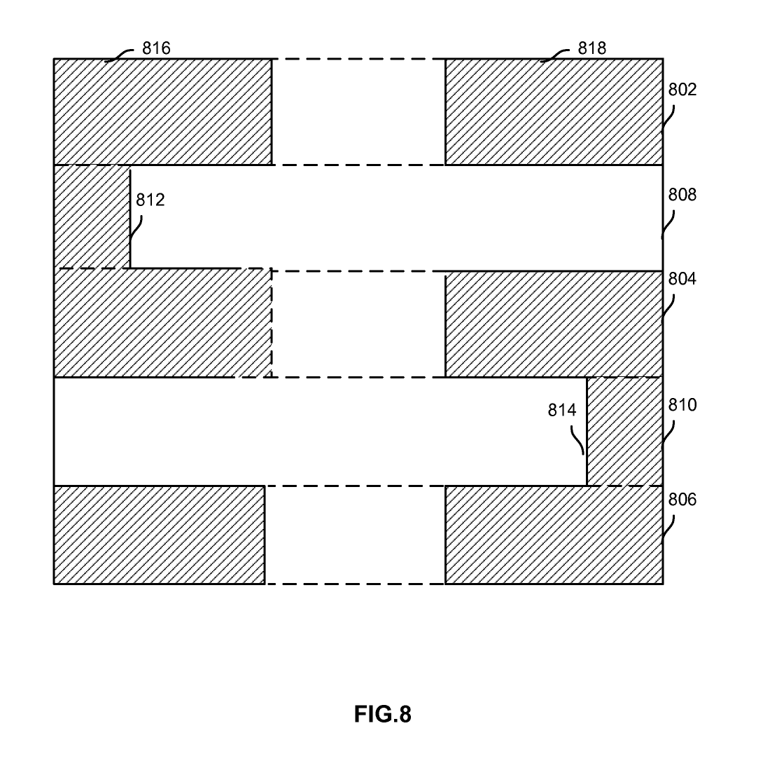

At 704, a planar structure comprising the windings and openings to receive the leg posts and center posts of two magnetic core halves is formed. In some embodiments, the planar structure is formed on a PWB. The windings can be formed by etching, electroplating, or other appropriate techniques on individual layers, laminated, and connected using vias as described below in connection with FIG. 8. The openings can be made by drilling on the laminated PWB.

At 706, the core portions and the planar structure are assembled to form a transformer. Specifically, the core portions are placed within the openings of the planar structure so that the leg posts extend through their corresponding openings to be surrounded by the windings, and the center posts extend through their corresponding openings.

FIG. 8 is a diagram illustrating an enlarged cross sectional view that corresponds to region 330 shown in FIG. 4B.

Only three conductive layers 802, 804, and 806 are shown for purposes of illustration, although additional layers are used in the circuit. Within the same layer, conductive portions such as 816 and 818 are electrically connected. The conductive layers are separated by insulating layers 808 and 810. To connect two adjacent conductive layers, vias such as 812 and 814 are formed by drilling openings in the insulating layers and filling the openings with conductive material (e.g., copper or other metal). In various embodiments, the size and locations of the vias may differ.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
specifying a WₐA_{c} product of a first transformer having a three-legged core;
determining a window area Wₐ of the first transformer;
determining parameters of the first transformer, including a core area A_{c}, a height of c, and a width of b;
specifying, based at least in part on the parameters of the first transformer, a second transformer having the WₐA_{c} product, the window area Wₐ, and the core area A_{c}, and comprising:
a first magnetic portion comprising:
a first plurality of leg posts that is to be surrounded by a first set of windings; and
a first plurality of center portions that is not to be surrounded by windings; and
a second magnetic core portion comprising:
a second plurality of leg posts that is to be surrounded by a second set of windings; and
a second plurality of center portions that do not receive windings.

2. The method of claim 1, further comprising specifying the second transformer to have: a height of d that is less than c, a width of b, a length of c.

3. The method of claim 1, further comprising specifying the second transformer to have: a height of d that is less than c, a width of b, a length of c, and wherein b=4\sqrt{2A_{c}/π}, c=8\sqrt{2A_{c}/π}, and d=5.6\sqrt{2A_{c}/π}.

4. The method of claim 1, wherein the second transformer is further specified to have a core base thickness
$$a = \frac{2 {A}_{c}}{b} .$$
